(19) United States
(12) Patent Application Publication
(10) Pub. No.: US 2012/0087490 A1
(43) Pub. Date: Apr. 12, 2012

(54) Method And Arrangement For Protecting File-Based Information

(75) Inventors: Ville Ollikainen, Vihti (FI); Juuso Pesola, Helsinki (FI)

(73) Assignees: ENVAULT CORPORATION OY, Vantaa (FI); ENVAULT CORPORATION OY, Vantaa (FI)

(21) Appl. No.: 13/377,260

(22) PCT Filed: Jun. 29, 2010
(86) PCT No.: PCT/FI10/50560

§ 371 Date: Dec. 9, 2011

(30) Foreign Application Priority Data
Jun. 29, 2009 (FI) 20090254
Jun. 29, 2010 (FI) PCT/FI2010/050560

(51) Int. Cl. H04L 9/28

(52) U.S. Cl. 380/28

(57) ABSTRACT

The invention represents a method for creating a ciphertext block from a plaintext block consisting of more than one consecutive plaintext character strings (M1, M2, . . . Mn), which are encrypted with an encryption block operating on counter mode. When encrypting a plaintext character string (M3, for example) a hash is formed from the preceding plaintext character string (M2). Preferably the hash is message authentication code MAC or CMAC, the generation algorithm of which uses as a key (Key2) the hash value formed from the plaintext character string (M1) preceding string M2. The hash formed from the plaintext character string (M2) is Counter input to encryption block (Ek) that outputs a key stream (Keystream 3). It is combined in XOR operation with the plaintext character string (M3) wherein the result is a cipher text character string (C3). The invention makes it possible to truncate a file size without losing information stored in the rest of the file.

### FIELD OF THE INVENTION

The invention is related data encryption and cryptography. More specifically, the invention relates to encrypting of a file-based data volume, partitioning data into two sections of different sizes so the smaller section is required to be able to utilize the larger one, to confirm the data integrity, and to recognize whether the data is encrypted or unencrypted.

### BACKGROUND OF THE INVENTION

Firstly, Processing of Block Mode Data is Discussed Below.

One of the handbooks of the art is the Handbook of Applied Cryptography (Discrete Mathematics and Its Applications), Alfred Menezes, Paul van Oorschot, and Scott Vanstone (CRC-Press, 1996, ISBN 978-0849385230).

In WO 03/088052, Andrew Tune teaches a way to partition data, such as credit card data, into two sections kept separately, locally, and on a server. Tune adds an tagto a local section based on which a section on a server can be retrieved and the sections combined with each other. The method taught by Tune does not, however, check the integrity of the restored data; neither does Tune cater for the processing of unencrypted data amongst encrypted data. In addition, Tune does not cover situations where one of the sections is modified afterwards, for example, by truncating it. Tune does not either teach how to minimize the size of the other data section.

A block mode data volume consists of several blocks of the same size into which data is saved. Each block has its own tag, usually a sequence number. This tag is generally called a block number.

Typical examples of block mode data volumes include computer mass storages, for example hard drives (HDD=Hard Disk Drive), or semiconductor-based non-volatile memories (SSD=Solid State Disk). Often, a file system using which data can be saved as files is created on a block mode data volume. When data is written in a mass storage or read from it, the writing or reading point is determined based on a logical block number (LBA). A file system attends, among others, to which position indicated by LBA data is written on each occasion and from where it is read. The writing itself is usually performed in full blocks, a typical block size being any power of two, most often at least 512 bytes.

Secondly, Encryption of Block Mode is Discussed Below.

For encrypting block mode data it is typically used a block cipher algorithm, such as AES-256 (FIPS 197, Advanced Encryption Standard (AES), 2001, National Institute of Standards and Technology, USA), using which a plaintext of certain length is modified into ciphertext using an encryption key. In many encryption algorithms, the size of a cipher block is, however, smaller than the block size of the data volume, for example, in said AES-256 it is 16 bytes. For this reason, to be able to encrypt a single data volume block, several cipher blocks have to be combined.

Several working modes have been described for combining cipher blocks, the most often used perhaps being CBC (Cipher Block Chaining). In the CBC mode, the ciphertext of the preceding block is combined to the plaintext of the following block using an exclusive OR (XOR) operation. If the size of the plaintext is not divisible by the size of the cipher block when using the CBC mode, the last block must be processed before encryption using, for example, the Ciphertext Stealing method. When changing file size afterwards, Ciphertext Stealing requires re-encryption using the original plaintext.

Thirdly, A Stream Cipher Technique is Discussed Below.

The encryption of plaintext block by block was described above. Another common way is the Stream Cipher method wherein plaintext is generally appended with a pseudorandom key stream using an XOR operation (the exact name of the method is “Additive Stream Cipher”). If the key stream is not identified, the restoring of plaintext cannot be done.

Fourthly, Message Authentication Codes (MAC) Are Discussed Below.

Let us start by specifying the term “hash”: A hash identifies data content with a data size that is smaller than the original data content. A characteristic of a good hash is that two data blocks of whatever similarity cannot produce the same hash. Another characteristic of a good hash is the distribution of control numbers over the whole number space in use.

Using non-linear transformations, such secure hashes can be produced in which the transformation only works in one direction. Additionally, it is difficult to specify a data content that produces the exact wanted secure hash. A hash can therefore be considered a control number that cannot be used to restore the actual data. Methods generally in use include, for example, SHA-256 and RIPEMD-160. These are generally considered good hashes.

Hashes can also be calculated in encrypted format, in which case they are typically message authentication codes (MAC=Message Authentication Code). Below follows discussion of FIG. 1. A method for calculating an authentication code is CMAC (NIST Special Publication 800-38B, 2005, National Institute of Standards and Technology, USA) that uses block cipher. CMAC divides the given encryption key K into two auxiliary keys K1 (106) and K2 (110) which are used when forming the authentication code (108). In CMAC, a plaintext block (101) is partitioned into character strings (102, 103, 104, and 109) of the size of the cipher block which are then input to the CBC mode concatenated encryption blocks (105). An XOR operation with the auxiliary key K1 (106) is executed on the last character string (104) of the plaintext block, if the last character string (104) is of same size with the cipher block. In other cases, the last character string is complemented to a full cipher block size with the bit 1 and the null bits following it, after which an XOR operation is executed with the auxiliary key K2 (110). The outcome is once more encrypted using the output encryption block (107) to yield an authentication code (108). The CMAC executing function that processes i^{th} consecutive character strings with the key K, beginning from the start of the plaintext block M, is as follows:

CMAC_{K}(M,i)=CMAC_{K}(M₁∥ . . . ∥Mᵢ) (i)

where the operator ∥ indicates the combination of two character strings.

Let it be noted that an authentication code can also be produced using a hash function, for example, using the HMAC method as follows:

HMAC(K,M)=H((K⊕opad)∥H((K⊕ipad)∥M)), (ii)

where opad and ipad are certain standard character strings, H is a hash function, K is a key and M is a message (for example, in plaintext format) HMAC is calculated from.

Fifthly, Errors in Ciphertext are Discussed Below.

Ciphertext may be missing data either on purpose or accidentally. In general, it is desirable to minimize the effect of missing data, for example, the characteristics of the aforementioned CMC mode include that when ciphertext is incorrect for a single cipher block, when restoring plaintext, the error is only reflected on the same and the next plaintext block.

When decrypting a stream ciphered ciphertext an error in the ciphertext produces an error in the corresponding position in the plaintext. If ciphertext is missing data or there is too much data, the mutual synchronization between the keystream and the ciphertext is lost, which results into all the restored plaintext after the error to be defective.

To avoid synchronization errors in decrypting the stream-ciphered ciphertext, a general procedure is used where created ciphertext is used to create a “self-synchronizing keystream”. Instead, plaintext is not as well suited for synchronization and it is not generally used.

In certain situations it is, however, desirable that an error produced in ciphertext on purpose is propagated to as large portion of the plaintext as possible.

Sixthly, CTR Encryption Mode is Discussed Below.

Below, FIG. 2 is discussed. CTR encryption mode (NIST Special Publication 800-38A, 2005, National Institute of Standards and Technology, USA) uses an encryption block (105) to the input of which is input a figure that is not repeated (201) and that is available in data restoring phase, in its simplest form a digit that is always one unit larger than the last one. The output of a encryption block is coupled to a single plaintext character string (103) of the same size as the cipher block using an XOR operation, whereby the final result is a ciphertext character string (202).

One of the significant benefits of the CTR encryption mode is that it can be used to encrypt such plaintexts the size of which is not divisible by the size of the cipher block. Truncating a file afterwards is possible, too.

Seventhly, Data Integrity is Discussed Below.

In practice, all block mode data volumes contain some extra information on the basis of which it is deductible whether the content read from the data volume has remained unchanged.

Traditionally, control numbers have been calculated for data blocks to ensure their data validity. For example, when saving each block on a hard drive, a control number is calculated on hardware level and saved with the block on the hard drive. When reading the block from the drive, the block control number is also read. If it does not match with the rest of the data in the block, either the data reading or writing can be found to have occurred incorrectly. Generally, for this purpose a CRC check sum has been used.

When the content of a block mode data volume is being encrypted, the content of the block exports the same mode when it's encrypted and unencrypted. Accordingly, there is no space in blocks for such extra information that could be used to confirm the success of encryption or decryption.

Eightly, Network Servers are Discussed.

An Internet connection is currently available almost everywhere, although it is not necessarily a broadband connection. For IP (Internet Protocol) data transfer between computers, secure protocols haven developed for which open source code libraries are available. For example, an OpenSSL library of open source code provides for SSL/TLS protocol support.

Ninthly, Here Follows Discussion of File Processing.

FIG. 3 shows a Windows operating system related model of how applications (301), such as Microsoft Word, write files onto a data volume (308). Roughly speaking, the file system driver stack (306) determines data location based on the file name and the internal location of the file. In the file system driver stack, data is being processed as sections of files, whereas the data volume driver stack (307) processes data as data volume blocks. In Windows operating systems, applications (302) and part of the operating system services (303) belong to usermode (304), whereas most drivers comply with kernelmode (305). To specify more clearly, although above—for clarity—it was mentioned that an application saved data, also, for example, operating system services and several programs in the driver stack may save and read files.

In the latest Windows operating systems, there are several interfaces for processing writable and readable data, the simplest of which is probably Minifilter. A person of the art may get a clear idea of Minifilter implementations through the model programs in the available Windows Development Kit, especially the Minispy application in which communication between usermode and kernelmode has been implemented.

Tenthly, Below Follows Discussion of Saving Data in a Data Volume.

In commonly used file systems, such as FAT, FAT32, exFAT, and NTFS, file size is determined by two alternative ways: If file writing is ends in a position which is greater than the preceding file size, file size is updated to reflect the end of the whole writing task. In the second place, file size can be determined explicitly to either a greater or a smaller size than the preceding file size.

There are two types of writing operations in Windows operating system driver stacks: cached and non-cached. A file system driver stack assigns the data to be saved to a data volume driver stack in a non-cached format and block by block as IRP (I/O Request Packet) messages. File size is typically determined either based on cached writing operations or explicit file size determinations.

Especially in Windows operating system driver stacks, there is a certain problem related to multilevel caching: If data to be written is modified in a driver stack, the modified data may, due to some anomalous situations, appear unmodified in the writing phase. This occurs, for example, in Windows XP/Vista operating system Minifilter implementations in NTFS file systems with small-sized files.

A fundamental problem occurs in situations where data to be written has been encrypted using block cipher and where file size is indivisible by the cipher block size. A special problem occurs in situations where file size is afterwards truncated as regards to a cipher block to an indivisible size, when writing operations have already been executed. In this case, data is lost in the last cipher block and the cipher block in question cannot be restored.

Finally, In the Following the Concept of Entropy is Reviewed.

Information entropy indicates the smallest possible bit number with which certain data can be represented. The entropy of a random number sequence is as large as the amount of numbers contained in it multiplied by the bit number of a single number.

The entropy of a completely pseudorandom number sequence corresponds to the entropy of a random number sequence, unless the production method of pseudorandom numbers is revealed. If it is revealed in its entirety, entropy is zero because in this case all values can be calculated unambiguously.

### OBJECTIVES OF THE INVENTION

A primary object of the invention is to enable changing the size of an encrypted file afterwards.

Further, another primary object of the invention is to protect data, preferably in such a way that the entropy in it is reduced by insufficiently saving the data in a protectable data volume, a small section of it being saved in another data volume.

A secondary objective of the invention may be to improve data reliability using a procedure where the integrity of encrypted data can be reliably authenticated.

### BRIEF SUMMARY OF THE INVENTION

A data volume to be encrypted comprises of a group of equal-size blocks. Each block is divided into equal-length plaintext character strings and then each plaintext character string is encrypted with a proper state-of-art encryption block generating a key stream that is XORed with the plaintext character string to be encrypted, which results in a cipher text character string. The invention is based on that the current plaintext character string or later plaintext character strings has no influence on encryption of the current plaintext character string, more precisely on the above-mentioned key stream, but only the previous plaintext character string or earlier plaintext character strings affect. This is implemented so that to the input of the encryption block is fed a hash value formed from one or more of the earlier plaintext character strings. Thereby the encryption block generates, according to its encryption algorithm, the key stream based on a key and the hash value.

The hash value is a message authentication code MAC calculated from at least one of the plaintext character strings preceding the plaintext character string to be encrypted

Alternatively, the hash value is a cipher-based message authentication code CMAC calculated from at least one of the plaintext character strings preceding the plaintext character string to be encrypted

The algorithm for calculating the MAC or CMAC of a plaintext character string is using a key. According to the further aspect of the invention, the MAC or CMAC of the preceding plaintext character string is used as the key. Thus, because the MAC or CMAC of the plaintext character string prior to said preceding plaintext character string has been used as the key for the MAC or CMAC of said preceding plaintext, etc., it can be stated that on a key used for calculating the MAC or CMAC of any plaintext character string is influenced by the MACs or CMACs of all the preceding plaintext character strings.

Preferably, the block cipher operates in Counter mode (CTR mode). A Hash of at least one of the plaintext character strings preceding the plaintext character string to be encrypted is applied to the Counter input of the encryption block. Preferably the encryption algorithm is AES, AES256 for example, wherein the encryption block is the known AES Counter mode Block cipher.

An aspect of the method may be the partition of the said ciphertext block into at least two sections of different sizes.

An aspect of the method may further include writing the file derived from plaintext blocks onto at least two memory devices, the first of which may be, for example, SSD based and in which at least the largest of the ciphertext block sections is saved as a file. The first memory device may be connected to a first computer, for example, a Windows workstation.

The method may further include the steps of connecting a second computer to the first computer via, for example, an information network, such as an IP protocol using network, and authorizing this connection based on either the said first computer, its user, or the said first memory device.

The method may also include the steps of saving at least the smallest of the ciphertext block sections in the said second computer.

Another aspect of the invention is a system executing the method, characterized by that it contains at least two memory devices onto which the said ciphertext block sections are saved.

The third aspect of the invention is a computer program executing the method, characterized by that it can create a ciphertext block from a plaintext block consisting of more than one consecutive character strings in such a way that, when creating the ciphertext block, at least one of the character strings in question is modified based on a hash derived from more than one preceding character strings included in the plaintext block.

### BRIEF DESCRIPTION OF THE DRAWINGS

FIG. 1 depicts the CMAC method of prior art for calculating an authentication code,

FIG. 2 depicts data encryption in accordance with the CTR mode of prior art,

FIG. 3 depicts a concept of prior art of saving data in a data volume,

FIG. 4 depicts an encryption arrangement of data according to an embodiment of invention,

FIG. 5 depicts a decryption arrangement of FIG. 4 corresponding to a data encryption arrangement of an embodiment of the invention,

FIG. 6 depicts the combination of the CMAC method and the CTR mode according to an embodiment of the invention,

FIG. 7 depicts the initiation of an arrangement according to an embodiment of the invention,

FIG. 8 depicts the optimized combination of the CMAC method and the CTR mode according to an embodiment of the invention,

FIG. 9 depicts a chart of components according to an embodiment of invention,

FIG. 10 depicts a chart of data distribution according to an embodiment of invention,

FIG. 11 depicts a data encryption arrangement according to an embodiment of invention,

FIG. 12 depicts the implementation of an embodiment of the invention in a Windows™ environment,

FIG. 13 illustrates the basic principle of the invention, and

FIG. 14 illustrates the use of an authentication code in CTR-mode.

### DETAILED DESCRIPTION OF THE INVENTION

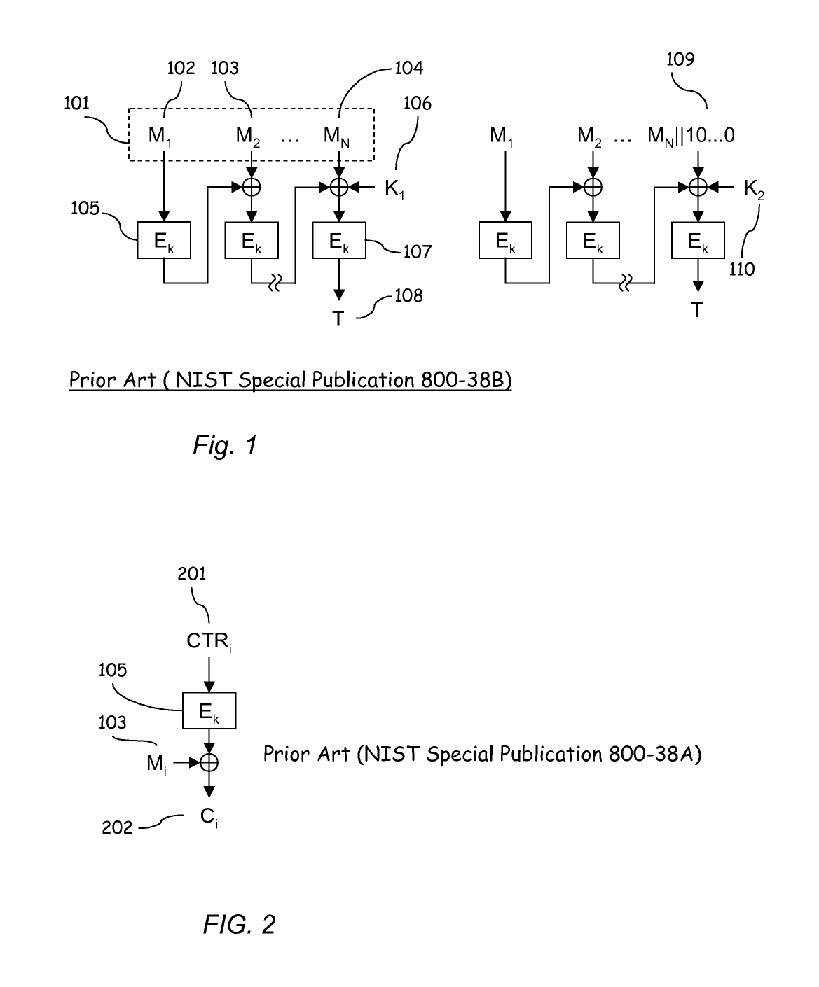

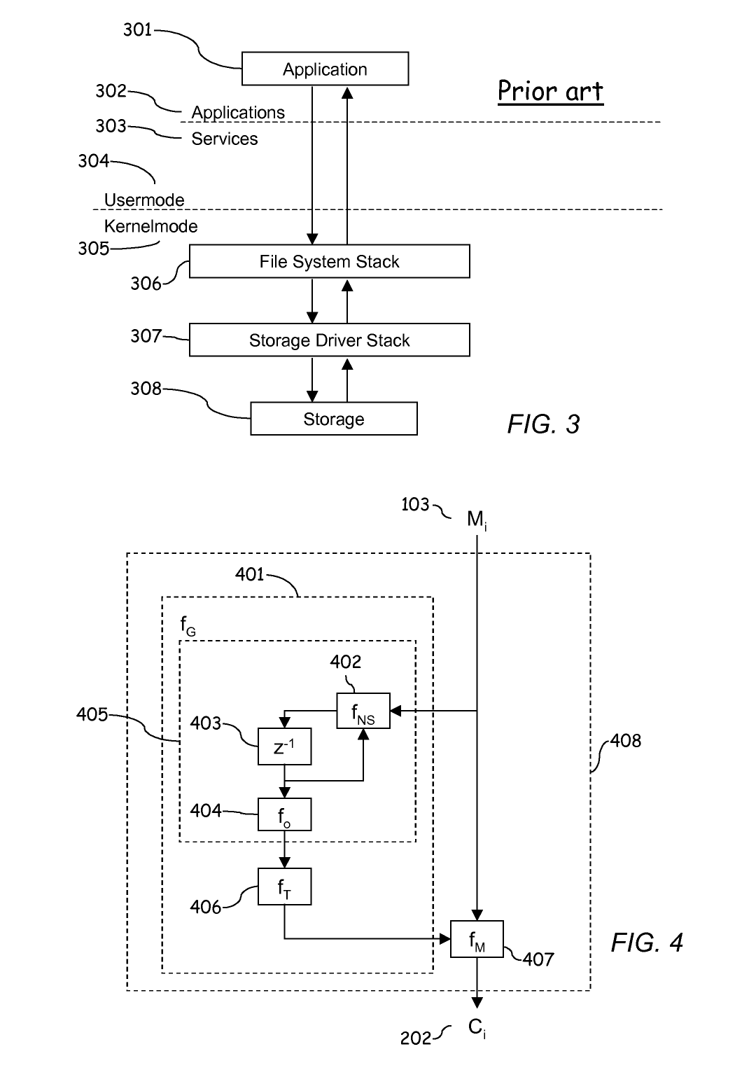

FIGS. 1, 2, and 3 describing the prior art have been explained in the section “Background of the Invention”. In the following, the invention is illustrated using its different embodiments and figures derived from them.

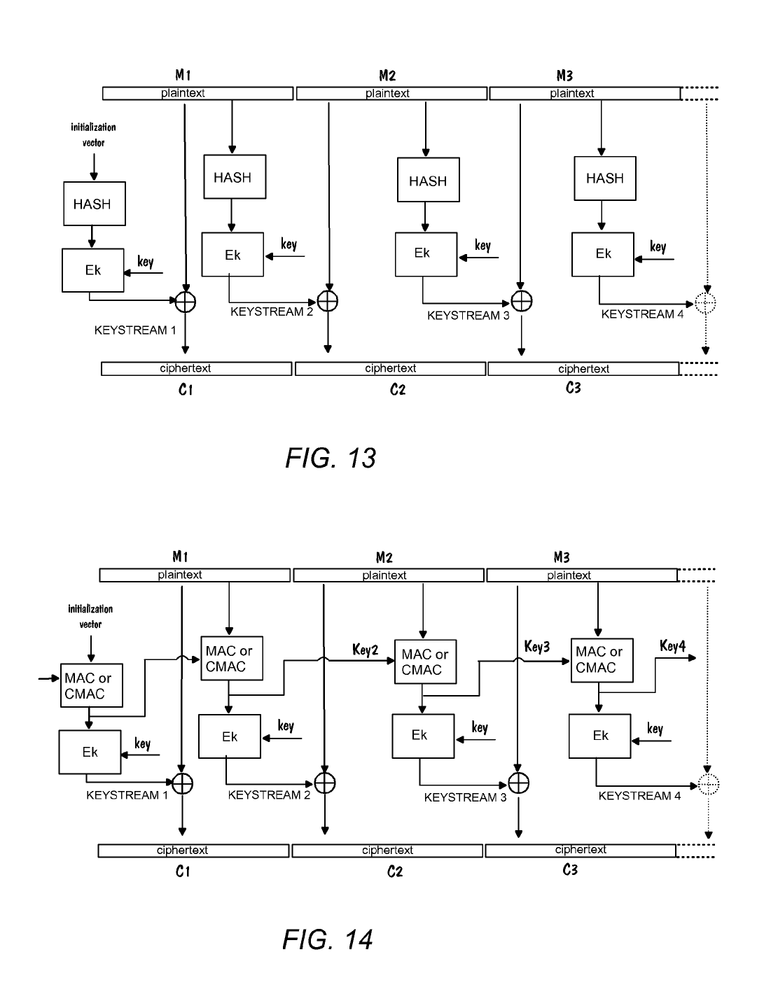

FIG. 13 illustrates the basic principle of the invention. As in the state of art, a plaintext block that is to be encrypted is first broken into equal-size plaintext character strings M1, M2, M3, . . . ,Mn. The length of the string is equal to the block size of the block cipher operating on Counter mode. The final string needs not to be of same size as other strings, but the amount of the bits in this string may be less than in the other strings. Thereafter each block is encrypted plaintext character string by plaintext character string so that a key stream generated by the encryption block is XORed with the plaintext character string. The encryption block generates according to its cipher algorithm the key stream based on the hash value applied to the Counter input and a key. In its simplest form the hash has been formed from the preceding plaintext character string only without using an encryption key.

When encrypting plaint text character strings it is extremely important to ensure that the same value is never applied to the counter input twice. Probability of two same values is almost zero if the has is formed as a secure hash. Reference is made to FIG. 14 illustrating encryption of plaint text character string M3. Cipher Ek is a known encryption block operating on Counter mode. A cryptographic Hash value formed from preceding plaintext character string M2 is fed to the counter input. MAC or CMAC algorithm, for example, having plaintext character string M2 and key Key2 as the inputs, generates this secure Hash. Key2, which is used as the key, is the secure Hash of previous plaintext character string M1. The secure Hash of plaintext character string M2 is fed to encryption block Ek that generates key stream Keystream3. It is combined by XOR operation with the bits of the plaintext character string M3 whereupon the result is cipher text string C3.

In this manner all plaintext character strings are encrypted. However, encryption of the first plaintext character string requires the use of an initialization vector as the secure Hash. In other words, when encrypting any plaintext character string the secure Hash is formed from the preceding plaintext character string using as the key the secure Hash of the previous plaintext character string. Therefore it can be stated that on the secure Hash used in encryption of a plaintext character string has been influenced by the Hash values of all preceding plaintext strings, but the plaintext character string to be encrypted has no influence on generating of the key stream used in encryption of said plaintext character string.

In a preferred embodiment of the invention, at least the first character string C₁ or part of it can be saved from a ciphertext block in a second memory device. Further, in a preferred embodiment the encryption is performed on a file by file basis in such a way that each cipher text block is saved in the same place in a file as the corresponding plaintext block would otherwise have been saved in. A person of the art is, for example, able to implement the Minifilter driver executing the Windows operating system encryption; the driver encrypts the file contents as described in the invention and maintains the original file name.

In the invention, encryption keys are preferably file-specific, they are also preferably saved on a second memory device.

Let us first look at FIG. 4 and the operation of the encryption method (408) described in the invention in a preferred embodiment of the invention: In the embodiment represented by FIG. 4, each plaintext character string (103) is modified based on the value of a mask function f_{G} (401). The internal state of the mask function (403) is maintained in a delay buffer. The internal state (403) is revealed to the outside of the mask function via the output functions fₒ (404) and f_{T} (406). The modifying of the i^{th} character string (103) of the plaintext into a ciphertext character string (202) is performed using a modification function f_{M} (407) the second parameter of which is the value of the mask function f_{G} (401).

Cᵢ=f_{M}(Mᵢ, f_{G}(M,i)) (iii)

The modification function (407) may preferably by an XOR operation; it is desirable that the plaintext character string (103) contains as many bytes as the value of the mask function (401). Other modification functions may also be used; it is essential that no such data following a ciphertext (202) or a plaintext character string (103), which might afterwards be truncated from the character string (202), may affect any values of the character string (202) within the modification function.

The next state of the mask function is provided by the function f_{NS} (402) which is backfed via the delay buffer maintaining the inner state (403). Let us describe the value of the function f_{Ns} using the designation f_{NS}(M,i) when processing the i^{th} character string:

f_{NS}(M,i)=f_{NS}(Mᵢ, f_{NS}(i−1)) (iv)

Therefore, it is essential for the invention that the value of the mask function f_{G} (401), when processing the i^{th} character string, is not dependent of the i^{th} plaintext character string but of the initial value z⁻¹₀ of the inner state (403) and of at least one possibly preceding character string, preferably for the invention, on all the preceding character strings of the same plaintext block. Let us designate:

f_{G}(M,i)=f_{G}(z⁻¹₀∥M₁∥M₂∥ . . . ∥Mᵢ₋₁) (v)

A preferred embodiment of the invention described in FIG. 4 illustrates a functional block (405) processing the inner state, the block calculating the message authentication code formed by the preceding plaintext character strings. The calculation of the authentication code typically involves an output function fₒ (404) of the inner state illustrated in the figure for generalization. It shall be noted that the output function fₒ (404) is not necessarily required if the output function f_{T} is considered to provide an adequate protection against the revealing of the inner state.

Further, let it be emphasized that although in FIG. 4 the inner state (403) is maintained in a delay buffer, the figure is conceptual in terms of the delay positioning, as a person of the art may plan different delay solutions in this invention: Essential for the mask function f_{G} (401) described in the invention is that its value, when processing the i^{th} character string, is independent of the i^{th} plaintext character string and dependent of the inner state initial value and of at least one preceding character string.

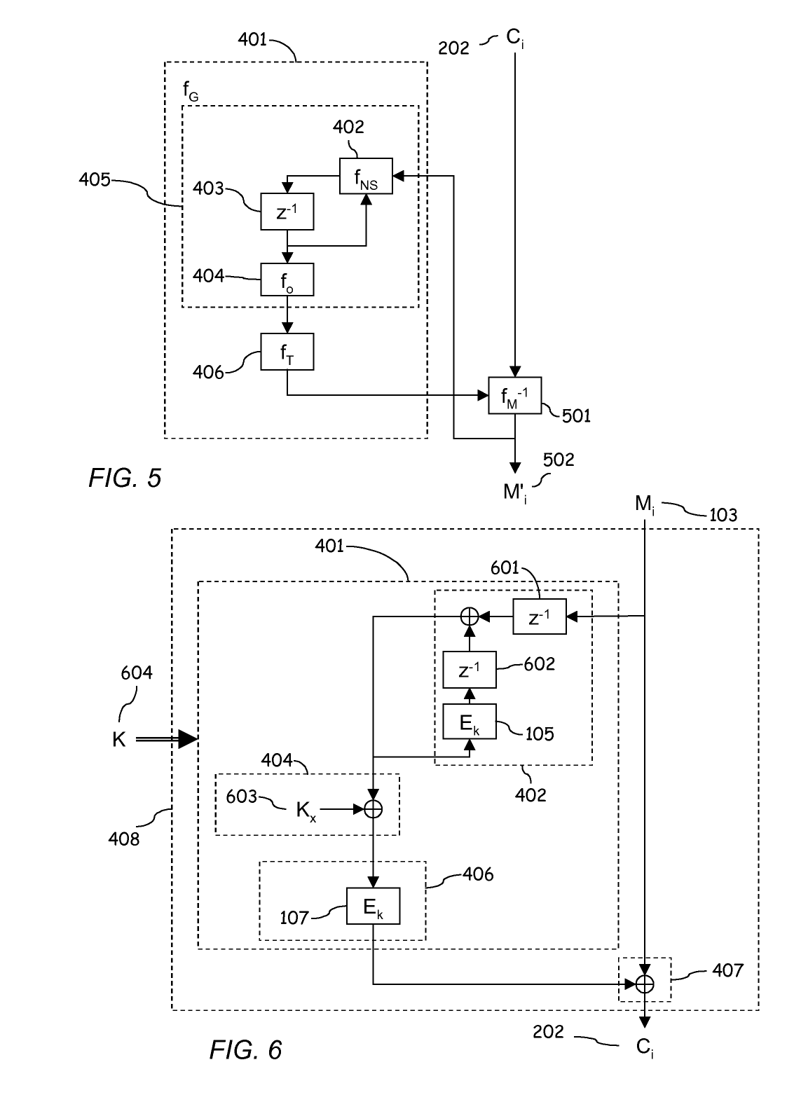

FIG. 5 is discussed below. It represents a preferred decryption from a ciphertext character string Cᵢ (202) to a plaintext character string M′ᵢ (502) corresponding to FIG. 4. The ciphertext block is processed with an invert function (501) of the modification function, its second parameter being the value of the same mask function (401) used also in encryption.

M′ᵢ=f_{M}⁻¹(Cᵢ, f_{G}(M,i)) (vi)

Because the value of the mask function f_{G} (401), when processing the i^{th} character string, is independent of the current plaintext character string and dependent only of z⁻¹₀ and the preceding character strings, the ciphertext block may be truncated from the middle of the i^{th} character string, the value of the mask function f_{G} (401) still being calculatable (cf. formula v).

Further, in the following the inverted function f_{M}⁻¹ (501) of the modification function f_{M} is discussed: Because in the modification function f_{M} no such piece of information following a ciphertext (202) or a plaintext character string (502), which might afterwards be truncated from the character string (202), may affect any values of the character string (202), an inverted function may also be calculated for truncated character strings. A preferred embodiment of the invention uses an XOR operation as the modification function f_{M}, the inverted function f_{M}⁻¹ of which is also XOR.

Below follows discussion of FIG. 6. In FIG. 6, preferably for the invention, a CTR mode complying XOR operation has been defined as the modification function (407), the output function (406) containing a encryption block (107) according to the CTR mode.

In the preferred embodiment of the invention represented in FIG. 6, CMAC mode has been redrawn using the drawing style of the mask function (401) shown in FIG. 4. CMAC operation has been delayed with a single character string using a plaintext delay (601). As mentioned before, a person of the art may plan different delay solutions. In fact, the inner state (403) in FIG. 4 is an XOR operation of the plaintext delay (601) and the cipher block delay (602) in FIG. 6. Modification function f_{M} (407) is a CTR mode complying XOR operation the inverted function f⁻¹_{M} (cf. 501 in FIG. 5) of which is XOR as well.

Especially noteworthy in a preferred embodiment of the invention shown in FIG. 6 is that the output function (406) is simultaneously both the encryption block (107 in FIG. 1) of the output of the CMAC method and the CTR encryption mode encryption block (105 in FIG. 2).

A review of the CMAC-CTR combination follows: To make the algorithm identical with the original CMAC, plaintext delay (601) and cipher block delay (602) could simply be initialized in such a way that, when processing the first plaintext character string, an XOR operation between their modes results in a null processed with decryption of its encryption (105). In this case, when the plaintext delay (601) gives a first plaintext character string M₁, the output of the cipher block delay (602) would be null and the block processing would be in accordance with CMAC.

However, this procedure would include a vulnerability: Even if the first character string C₁ from the ciphertext block was only saved in a second memory device, the value of the output function (406) would be same for each first character string. Further, if the same keys are used to process several ciphertext blocks, it would be completely possible to have blocks where the first character string M₁ of the plaintext block would be the same, which would result into an identical ciphertext block C₁. Hence, known ciphertext blocks C₁ could be adapted into the place of unknown ciphertext blocks C₁′: Thus, with a good guess or abundant tests, at least the protection of the character string M₂ could be weakened.

Using the teaching of the CTR mode and as a solution to this vulnerability, preferably for the invention, plaintext delay (601) and cipher block delay (602) can be initialized in such a way that an XOR operation between them produces a unique number. In practice, for example, plaintext delay (601) can be initialized as null and cipher block delay (602) initialized using such a counter that does not produce two same figures for plaintext blocks within a reasonable timeframe. A person of the art may, when implementing the counter, use a CTR mode counter as a basis.

In terms of the security of the invention, it is preferred that the same encryption key/counter value combination is practically never repeated. If the invention is implemented as a Minifilter implementation, each file may be given its own encryption keys and the counter may be derived from the location where the data block in question is written to.

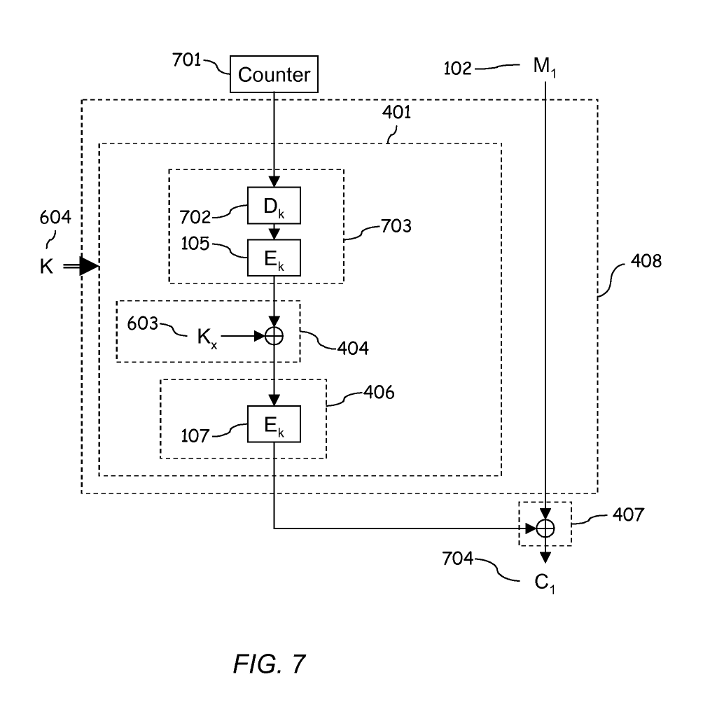

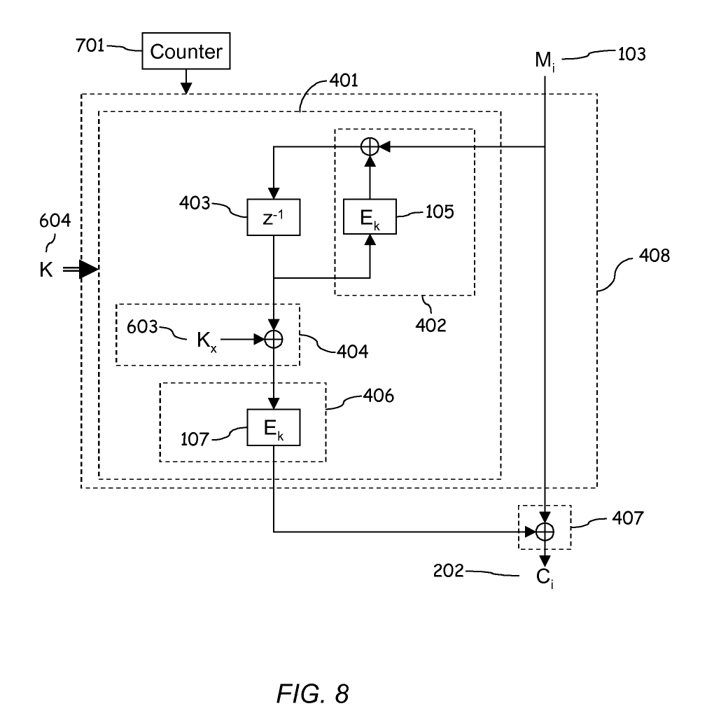

Referring to the example of FIG. 7, below is discussed a preferred implementation of the counter to initialize inner state (403) for each first character string M₁: Because the encryption block E_{K} (105) and the decryption function D_{K} (702) are inverted functions of each other, their combination (703) yields the value of the counter. Therefore, if the inner state initial value z⁻¹₀ is the value of the aforementioned counter (701) which has been processed with a decryption operation, i.e.

z⁻¹₀=Counter (vii)

In this case, CMAC in fact produces an authentication code from the character string that is logically the value of the counter when processed with a decryption function and appended with the preceding character strings of the same plaintext block.

CMAC_{K}(i−1)=CMAC_{K}(D_{K}(Counter)∥P¹∥P₂∥ . . . ∥Pᵢ₋₁) (viii)

In other words, it is still a CMAC method described in NIST Special Publication 800-38B; even if a counter was appended to it, only the value derived from the counter would be inserted in front of the data. Further, let it be noted that in FIG. 7 the self-annulling combination (703) has only been represented for this uniformity review and its implementation is not technically appropriate.

Thus, the character string C₁ (704) of the first ciphertext is:

C₁=P₁⊕CMAC(D_{K}(Counter)) (ix)

The discussion of the embodiment represented in FIG. 6 is continued below. The output function f_{T} (406) is a block cipher arrangement according to CMAC wherein, before the encryption block (107), an XOR operation is executed on the internal state (403) with the auxiliary key Kₓ (603) derived from the encryption key K (604). As the character strings to be written are full-length strings in IRP messages of Windows, when complying with CMAC, Kₓ is the auxiliary key K₁ and the auxiliary key-K₂ is not required. In applications where a character string does not cover the whole cipher block, Kₓ for an incomplete block is not required as the value of the output function (406) would only be required to encrypt the next character string. Thus, K₂ is left unused.

When processing the first character string M₁, use of K₂ in the output function (404) instead of K₁ may be preferred for the invention because, as noted below, at least the first character string or a part of it can be saved only in another memory device. In this case, neither of the memory devices has to contain character strings processed both with K₁ and K₂. Since K₂ is from internal state (403 in FIG. 4), i.e. it is independent of the XOR of plaintext delay (601) and ciphertext delay (602), the result of the XOR operation of K₁ and internal state is as random as the result of the XOR operation of K₂ and internal state. Thus, K₂ may be used instead of K₁ when encrypting the first character string M₁.

In the embodiment shown in FIG. 6, CMAC produces an authentication code after each character string. It is preferable for the invention that if the used encryption block (107) is of good quality, such as EAS, internal state (403) is evenly distributed over the whole number space in use due to the bijectivity of both the authentication code and the encryption block. As a consequence of this, CTR mode can safely be used as shown in this embodiment of the invention:

For the safety of the CTR mode, it is essential that the same value of the counter is not repeated. According to a birth date paradox well know to a person of the art, when using a 16-byte cipher block, for example, the counter gets two exactly same values with a probability of 50% only when approximately 300 exabytes (300×10¹⁸ bytes) have been written. This is believed to be enough for any imaginable applications.

Let us discuss FIG. 8 which represents a functionally similar but more optimized version to that of the embodiment shown in FIG. 6: The plaintext delay (601) and the cipher block delay (602) of FIG. 6 have been combined into a delay buffer maintaining the inner state (403). Especially noteworthy in this preferred embodiment of the invention is the maintaining of the inner state (403) in a delay buffer, and for this reason the value of the mask function (401) when processing the i^{th} character string is still

F_{G}(i)=CMAC_{K}(i−1) (x)

In other words, the output of CMAC has been delayed with a single character string, as is also the case in the embodiment shown in FIG. 6.

When striving for a simple implementation, the inner state initial value z⁻¹₀ is preferably initialized with the value of the counter (701) described for FIG. 7, i.e.

Z⁻¹₀=Counter (xi)

whereby the review in FIG. 7 relating to the safe combination of CMAC and CTR still applies.

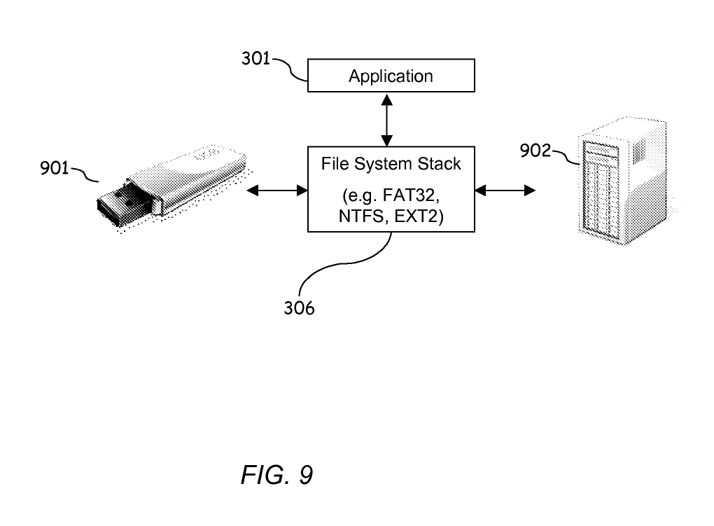

Below follows discussion of FIG. 9. As above mentioned, in a preferred embodiment of the invention at least the first character string C₁ or part of it is saved from a ciphertext block in another memory device. Because the decryption of the ciphertext character string Cᵢ requires the already decrypted character strings M₁-Mᵢ₋₁, it is preferred to transfer data onto a second memory device specifically from the beginning of the ciphertext block. This data is thus preferably removed from the first memory device (901), which functions as the primary ciphertext storage medium. Proceeding in this way, access to plaintext can be adjusted by allowing and denying access to the second memory device (902).

In FIG. 9, a preferred concept is represented where the data written by a software (301) is processed, for example, in a driver stack (306) processing a Windows file system; the driver stack partitions the data onto two separate memory devices, the first (901) and the second (902) one. When an application reads data, it is accordingly combined from the data read from the first (901) and the second (902) memory device. In this description, for clarity, the term “application” is used; it is apparent to a person of the art that also, for example, operating system services and several programs in a driver stack can save and read data similarly as any applications.

It should probably be noted that a person of the art is easily able to implement a method where data partitioned into several sections is combined to form the original data, as long as the way partitioning was executed is well specified. Similarly, it should probably be noted that a person of the art is easily able to implement data partitioning into more than two sections if there is a need for partitioning data into several sections.

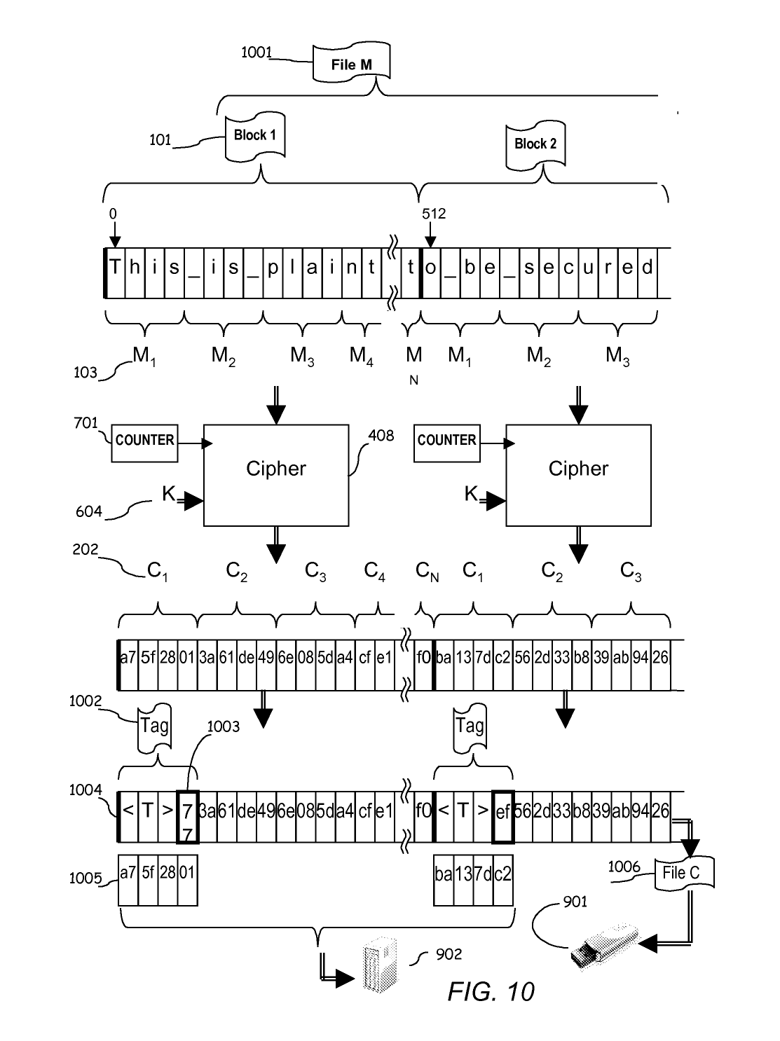

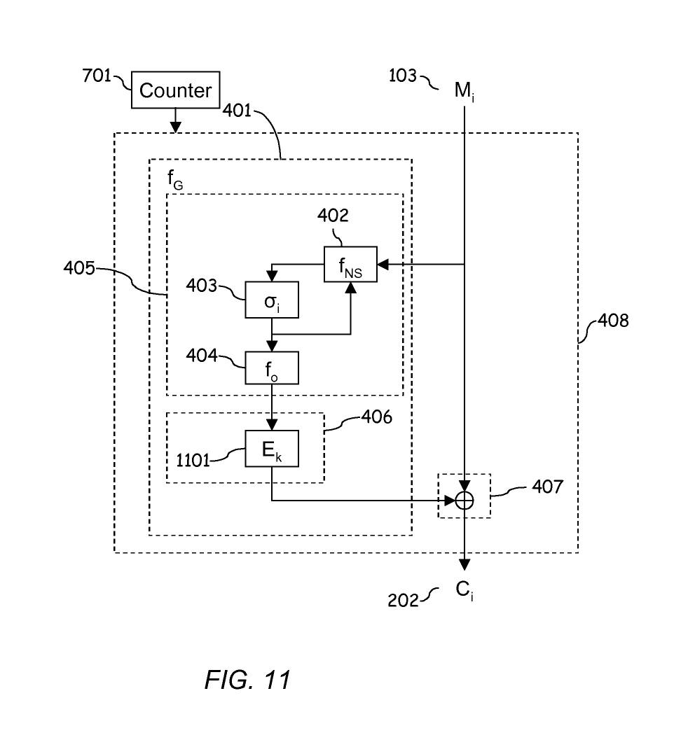

Below follows discussion of FIG. 10 which represents more accurately a preferred way of partitioning data onto two memory devices using the inventive method. A file (1001) to be written is partitioned in a driver stack processing the file system into plaintext blocks of identical size (101) which are further partitioned into character strings of the same size (103). Each plaintext block is encrypted using the encryption (408) described above, by transforming the plaintext block (101) into cyphertext character strings (202). In a preferred embodiment of the invention, it is preferred to remove from the file (1006) to be saved in the first memory device (901) the first ciphertext character string (1005) corresponding to each plaintext block and to save it in another memory device (902).

For all the embodiments of the invention, it is preferred that restoring of each cipher text character string is affected by the data removed from the first memory device and saved in the second memory device.

At the same time, space is freed from the data (004) saved in the first memory device in those locations where data was removed and transferred onto the second memory device (902). In the invention, it is preferred to replace the ciphertext character string (1005) removed from the data saved in the first memory device with an authentication tag (1002) using which, in the reading phase, the encryption status of the block can at least be indicated. Proceeding in this manner, especially those situations occurring in Windows operation systems can be avoided where caching restores—yet in an unencrypted format—data presumed to be encrypted.

In a preferred embodiment of the invention, the authentication tag(1002) is appended with the data (1003) required for checking integrity. This integrity check data (1003) is preferably calculated using a secure hash describing the contents of a plaintext block (101), the hash using a key not used in block ciphering. The key of the said hash is preferably derived from the key used in encryption; additionally, it has to be remembered that the above mentioned key K₂ is available for use. A person of the art is able to plan integrity check data (1003) in such a way that the data required for checking integrity does neither reveal the key nor the fact whether there are two blocks with same content on the memory device. A preferred way of confirming that no blocks with the same content are revealed is to append a character string, for example, in its beginning, before integrity calculation, with such data unique for each encryption key which is known in reading phase before decryption. This data can, for example, be derived from a plaintext block (101) sequence number within a file and possibly from a file-specific tag.

It has to be noted that the file may be truncated also on the encryption tag (1002) whereby it is preferred to make a conclusion in the writing phase based only on the first section. If the beginning of an encryption tag is broken in two matches and the preceding block had been encrypted, the beginning of a cipher Mode block is retrieved from another memory device (902). It is preferred that the encryption tag (1002) starts with a clearly identifiable character string: If the original file (1001), and thus also the encrypted file (1006), is smaller than the encryption tag, accordingly it a conclusion may be made based on, for example, whether or not the other files of the same type included in the same first memory device (901) are encrypted on default. In case the file is small, a person skilled in the art may have to make case-specific conclusions although it has to be remembered that in practical planning it is preferable to strictly define which files are to be protected by the invention and which not—an exception to this indicates as such an error condition.

Because in this preferred embodiment of the invention data is removed from the beginning of the cipher text blocks saved in a memory device, it is further preferred, in terms of the invention, that the removed data affects the restoring of all the other character strings from the same plaintext block.

Let us further look at the preferred embodiment presented in FIG. 11 which is derived from the teaching originated in connection with FIGS. 4 and 7 for using a counter. In general, the CTR encryption mode presented in the NIST Special Publication 800-38A is considered safe if the encryption block (105) used in it, and presented also in FIG. 2, is safe. For example, AES-256 is generally considered a safe encryption block. In addition, the value of the counter (701) may not be repeated. In an embodiment of the invention preferred in terms of its performance, although more limited in terms of its data security, the value of the counter is produced using a hash algorithm faster than CMAC, but cryptographically less powerful, as long as the output function (406) is a proven encryption block (1101), such as AES. A faster hash algorithm may be added to the key using, for example, the said HMAC method. Additionally, it is preferable to note the above-described teaching related to using the counter for formatting an internal state.

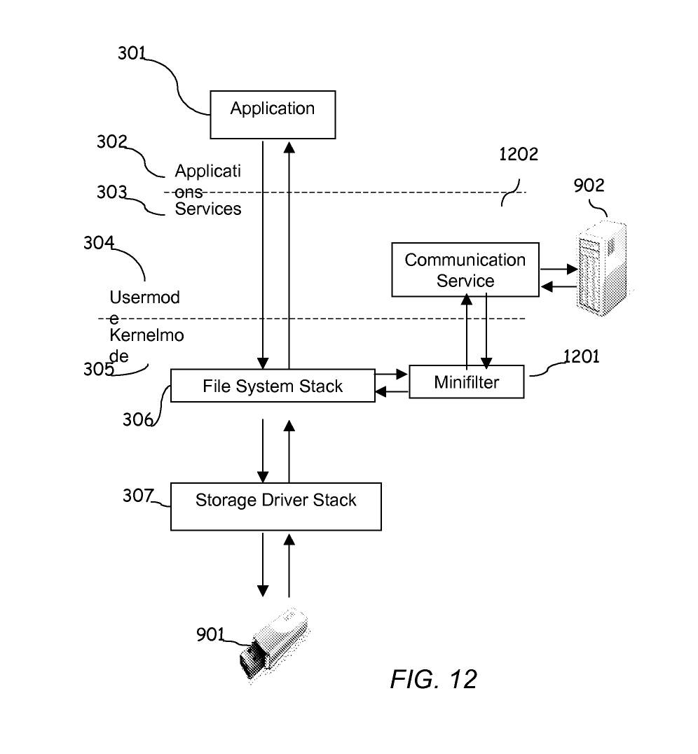

Finally, below follows discussion of an embodiment of the invention presented in FIG. 12 in a Windows™ environment. Using data communications protocols from driver programs, especially from Minifilter implementations, is inconvenient which is why it is maybe easier to implement alongside the Minifilter (1201) executing the encryption algorithm of the invention a usermode communication software (1202) acting as a Windows service for the IP communication possibly required by the server acting as a second memory device (902). Data transfer between kernelmode (305) and usermode (304) is taught by Windows Installable File System Development Kit's model project called FileSpy. A person skilled in the art is able to implement the IP communications in accordance with the prior art to authenticate access based on a user, first memory device, or a computer. In addition, a person skilled in the art is able to encrypt data communications, for example, using established practices, such as SSL/TLS.

In the description of the invention thus far, only file truncation has been mentioned. Let it be noted that extending a file is also possible. In general, data is written in the truncated part of the file afterwards. This, as well as other data volume writings, is performed on a block by block basis whereby the protection described as the invention functions normally. If the file is only extended and not written on, the file content is generally unspecified in terms of the extension and its contents is not to be trusted. Accordingly, the application of the invention does not essentially weaken the functioning of the memory device—not even in terms of file extension.

Modifications of the invention are easily made based on the description and guided by the represented representative embodiments. Data can, for example, partitioned into more than two sections, and it may be removed from a primary data volume in different quantities. Additionally, for example, only one Windows™ based Minifilter implementation was represented as an embodiment of a driver software, however, the invention may also be used in other architectures utilizing the inventional concept presented here.

1. Method for creating a ciphertext block from a plaintext block, which is divided into consecutive plaintext character strings to be encrypted in succession, characterized in that a block cipher operating on Counter mode is used as an encryption block, and that the method further comprises the steps of:
generating a hash at least from the preceding plaintext character string using a hash function,
applying the hash to the counter input of the encryption block, to other input of which is applied encryption key K, wherein a key stream is obtained from the output, and
feeding the plaintext character string to be encrypted and the key stream as inputs to XOR-function that outputs a cipher text character string, wherein the hash used in encryption of the plaintext character string is independent of this string and the subsequent plaintext character strings.

2. The method according to claim 1, characterized in that the encryption block operates on AES-Counter mode.

3. The method according to claim 1, characterized in that the hash function is a cryptographic Hash algorithm.

4. The method according to claim 1, characterized in that the hash code generated by the hash function is the message authentication code MAC or cipher-based message authentication code CMAC.

5. The method according to claim 3 or 4, characterized in that as the key for the message authentication code is used a message authentication code formed from second plaintext character string before the plaintext character string to be encrypted, wherein the key includes influence of all the preceding message authentication codes.

6. The method according to claim 1, characterized in that at least one of the said cipher text blocks is partitioned into at least two sections of different size, which are saved in separate memory devices.

7. The method according to claim 1, characterized in that the first cipher text character string formed from the first plain text character string of the plaintext block is stored in a second memory device and other cipher text character strings are stored in a first memory device.

8. The method according to claim 6 or 7, characterized in that the first memory device is a removable memory and is connectable to a first computer, and the second memory connected to a second computer, wherein the first computer can be connected to a second computer via a telecommunication network for obtaining the other cipher text character strings stored therein.

9. Arrangement for creating a cipher text block from a plaintext block, which is divided into consecutive plaintext character strings to be encrypted in succession,
characterized in that the arrangement comprises:
a hash generating block that generates a has value from at least one of the plaintext character strings preceding the plaintext character string currently being encrypted,
a block cipher operating on Counter mode, to the counter input of which is fed said hash value and to the key input of which is fed a key K, wherein a key stream is obtained from the output,
means for performing XOR-function, into which are fed the plaintext character string to be encrypted and the keys stream, and from output of which a cipher text character string is obtained,
wherein the hash value used in encryption of the plaintext character string being currently encrypted is independent of this string and the subsequent plaintext character strings.

10. The arrangement according to claim 9, characterized in that the block cipher operates on AES-Counter mode.

11. The arrangement according to claim 9, characterized in that the hash generating block generates one of message authentication code MAC, cipher-based message authentication code CMAC.

12. The arrangement according to claim 11, characterized in that as the key for the hash generating block is used a message authentication code formed from second plaintext character string before the plaintext character string to be encrypted.

13. The arrangement according to claim 9, further comprising means for storing the first cipher text character string formed from the first plain text character string of the plaintext block in a second memory device and other cipher text character strings in a first memory device.

14. A computer program for encrypting successive plain text character strings, characterized in that the program comprises:
a hash generating block enabled to generate a has value from at least one of the plaintext character strings preceding the plaintext character string currently being encrypted,
a cipher block operating on Counter mode, forming a key stream in response to a hash value fed to the counter input and a key fed to the key input,
a block performing XOR-function that produces a cipher text character string in response to a plaintext character string to be encrypted and the key stream.

15. The computer program as in claim 14, characterized in that the hash generating block runs MAC or CMAC algorithm.
